(19) United States
(12) Patent Application Publication
(10) Pub. No.: US 2023/0404302 A1
(43) Pub. Date: Dec. 21, 2023

(54) PILLOW AND METHOD OF MAKING SAME

(71) Applicant: Precision Textiles LLC, Fairfield, NJ (US)

(72) Inventors: Robert O'Connell, JR., Fairfield, NJ (US); Scott Tesser, Fairfield, NJ (US)

(21) Appl. No.: 18/212,592

(22) Filed: Jun. 21, 2023

Related U.S. Application Data
(60) Provisional application No. 63/353,955, filed on Jun. 21, 2022.

(51) Int. Cl. A47G 9/10

(52) U.S. Cl. CPC A47G 9/10

(57) ABSTRACT

A pillow includes a first pillow half having an outer surface and an inner surface and a second pillow half having an outer surface and an inner surface. The inner surface of the first pillow half contacts the inner surface of the second pillow half. The first pillow half defines a first interior concavity in the inner surface of the first pillow half. The first interior cavity extends into an interior of the first pillow half.

### CROSS-REFERENCE TO RELATED APPLICATIONS

This application is a Section 111(a) application relating to and claiming the benefit of commonly owned, co-pending U.S. Provisional Patent Application No. 63/353,955, filed Jun. 21, 2022, entitled “PILLOW AND METHOD OF MAKING SAME,” the contents of which are incorporated herein by reference in their entirety.

### FIELD OF THE INVENTION

The present invention relates to bedding and sleep products, and, more particularly, to pillows.

### BACKGROUND OF THE INVENTION

Each year in the United States alone, hundreds of millions of people sleep billions of nights, for trillions of hours. A majority of these people rest their heads on pillows. Current pillow designs often absorb too much heat from the users, and do not provide adequate support of the users' necks and heads.

### SUMMARY OF THE INVENTION

In an embodiment, a pillow comprises a first pillow half including an outer surface and an inner surface opposite the outer surface; and a second pillow half including an outer surface and an inner surface opposite the outer surface, wherein the inner surface of the first pillow half contacts the inner surface of the second pillow half, and wherein the first pillow half defines a first interior concavity in the inner surface extending into an interior of the first pillow half.

In an embodiment, the first pillow half defines at least one surface concavity on the outer surface thereof. In an embodiment, the first pillow half defines a plurality of surface concavities on the outer surface thereof. In an embodiment, the second pillow half defines a plurality of surface concavity on the outer surface thereof. In an embodiment, the second pillow half defines a second interior concavity in the inner surface extending into an interior of the second pillow half, the second interior concavity aligned with the first interior concavity. In an embodiment, the first pillow half defines at least one vent in the outer surface extending into the interior of the first pillow half.

In an embodiment, the at least one vent is defined in the at least one surface concavity of the first pillow half. In an embodiment, the second pillow half defines at least one vent in the outer surface extending into the interior of the second pillow half. In an embodiment, the at least one vent is defined in the at least one surface concavity of the second pillow half. In an embodiment, the first pillow half defines a plurality of vents in the outer surface extending into the interior of the first pillow half, and the second pillow half defines a plurality of vents in the outer surface extending into the interior of the second pillow half. In an embodiment, the vents extend into the interior concavities. In an embodiment, the first pillow half comprises a molded polyurethane.

In an embodiment, a pillow comprises a first pillow half including an outer surface and an inner surface opposite the outer surface; a second pillow half including an outer surface and an inner surface opposite the outer surface; and a support layer having a first surface and a second surface opposite the first surface, wherein the inner surface of the first pillow half contacts the first surface of the support layer, wherein the inner surface of the second pillow half contacts the second surface of the support layer, and wherein the first pillow half defines an interior concavity in the inner surface extending into an interior of the first pillow half.

In an embodiment, a method comprises molding a first pillow half including an outer surface, an inner surface opposite the outer surface, and an interior concavity in the inner surface extending into an interior of the first pillow half; molding a second pillow half including an outer surface and an inner surface opposite the outer surface; and connecting the inner surface of the first pillow half and the inner surface of the second pillow half, thereby to form a pillow.

In an embodiment, molding the second pillow half comprises molding a second interior concavity in the inner surface extending into an interior of the second pillow half, the second interior concavity aligned with the first interior concavity. In an embodiment, molding the first pillow half comprises molding at least one vent in the outer surface of the first pillow half, the at least one vent extending into the interior of the first pillow half. In an embodiment, molding the second pillow half comprises molding at least one vent in the outer surface of the second pillow half, the at least one vent extending into the interior of the second pillow half.

In an embodiment, a method comprises molding a first pillow half including an outer surface, an inner surface opposite the outer surface, and an interior concavity in the inner surface extending into an interior of the first pillow half; molding a second pillow half including an outer surface and an inner surface opposite the outer surface; obtaining a support layer including a first surface and a second surface opposite the first surface; connecting the inner surface of the first pillow half and the first surface of the support layer; and connecting the inner surface of the second pillow half and the second surface of the support layer, thereby to form a pillow.

### BRIEF DESCRIPTION OF THE DRAWINGS

For a more complete understanding of the present invention, reference is made to the following detailed description of exemplary embodiments considered in conjunction with the accompanying drawings, which are presented for the purpose of illustration rather than being drawn to scale, and in which:

FIG. 1 is an isometric top view of some embodiments of a pillow formed from two pillow halves;

FIG. 2 is an exploded isometric view of the pillow of FIG. 1;

FIG. 3 is a top view of a pillow half of FIG. 1;

FIG. 4 is a bottom view of the pillow half of FIG. 2;

FIG. 5 is a cross-sectional view, taken along line V-V and looking in the direction of the arrows, of the pillow half of FIG. 3;

FIG. 6 is an exploded isometric view of some embodiments of a pillow;

FIG. 7 is a top view of a support layer of the pillow from FIG. 6; and

FIG. 8 illustrates a cross section of some embodiments of a pillow.

### DETAILED DESCRIPTION OF THE DRAWINGS

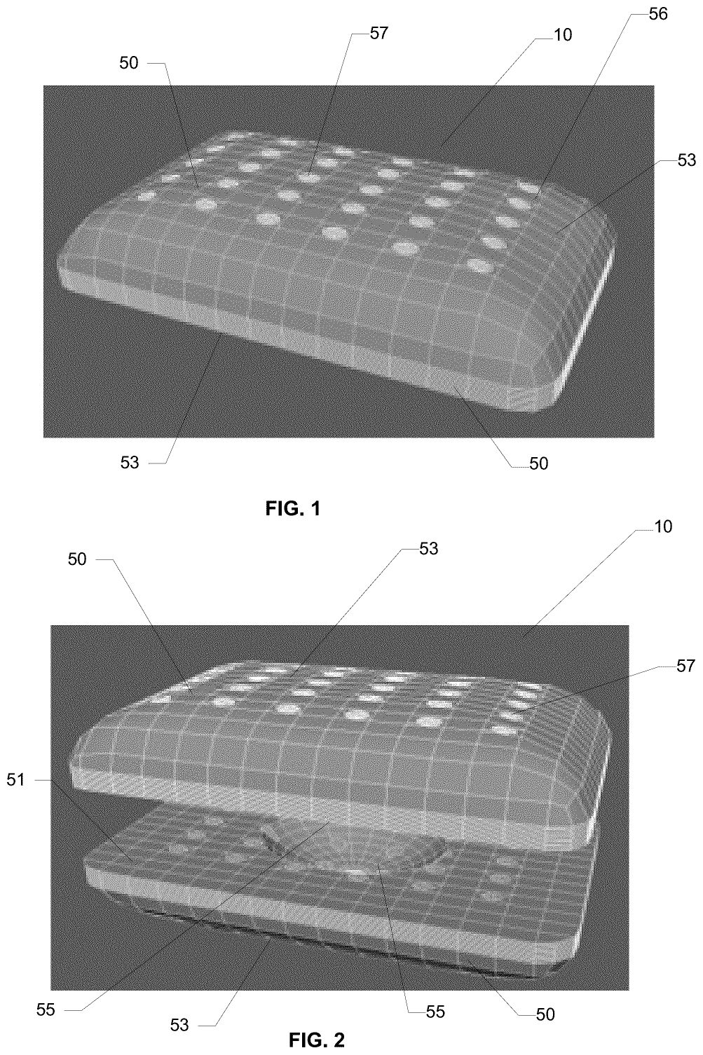

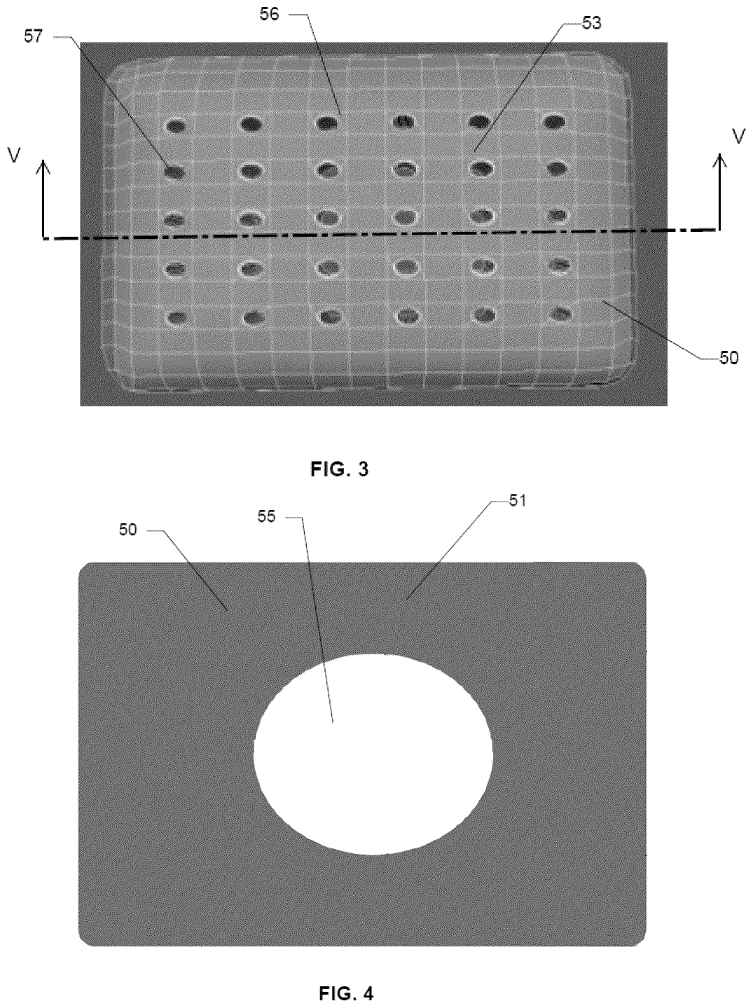

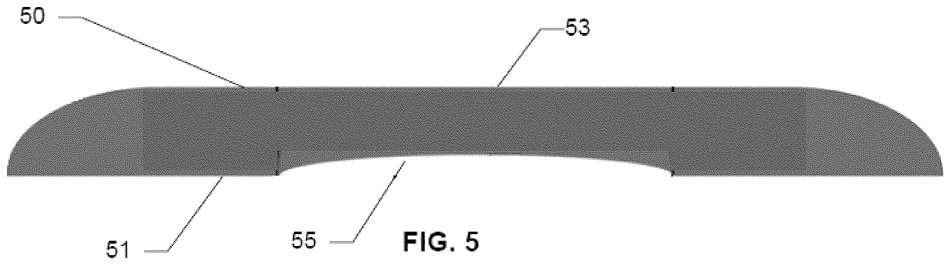

FIG. 1 is an isometric view of a pillow 10 including one pillow half 50 connected to another pillow half 50. FIG. 2 is an exploded isometric view of the pillow 10. FIG. 3 is a top view of one pillow half 50. FIG. 4 is a bottom view of one pillow half 50. FIG. 5 is a cross-sectional view of one pillow half, taken along line V-V in FIG. 4. As shown in FIGS. 1-5, each pillow half 50 is generally rectangular in shape when viewed from the top and bottom. When viewed from the side, each pillow half 50 includes radiused sides. As also shown, each pillow half 50 includes an inner surface 51 and an outer surface 53, the inner and outer surfaces opposite one another. Each inner surface 51 is generally flat, and the inner surface 51 of one pillow half 50 contacts the inner surface 51 of the other pillow half 50 when forming the pillow 10. In an embodiment, each outer surface 53 has a generally flat center, although sides of the outer surface 53 are radiused. When one pillow half 50 forms the pillow 10 with the other pillow half 50, one outer surface 53 contacts the head of a person using the pillow 10, for example, when the other outer surface 53 contacts a bed surface, for example.

In an embodiment, the pillow 10 is a queen-size pillow and each pillow half 50 is 70 cm in length. In an embodiment, the pillow 10 is a queen-size pillow and each pillow half 50 is 43 cm in width. In an embodiment, the pillow 10 is a queen-size pillow and each pillow half 50 is 6.5 cm in height, so that an overall height (thickness) of the pillow 10 is 13 cm. In an embodiment, the pillow 10 is a queen-size pillow and each pillow half 50 is 70 cm in length, 43 cm in width, and 6.5 cm in height, so that an overall height (thickness) of the pillow 10 is 13 cm.

In an embodiment, the pillow 10 is a king-size pillow and each pillow half 50 is 85 cm in length. In an embodiment, the pillow 10 is a king-size pillow and each pillow half 50 is 43 cm in width. In an embodiment, the pillow 10 is a king-size pillow and each pillow half 50 is 6.5 cm in height, so that an overall height (thickness) of the pillow 10 is 13 cm. In an embodiment, the pillow 10 is a king-size pillow and each pillow half 50 is 85 cm in length, 43 cm in width, and 6.5 cm in height, so that an overall height (thickness) of the pillow 10 is 13 cm.

As shown in the figures, each pillow half 50 includes an interior concavity 55 that is formed in the inner surface 51 and extends into an interior of the pillow half 50, such that the pillow half 50 defines the interior concavity 55. The interior concavity 55 is centrally-located, and elliptical or oval in shape. In an embodiment, the interior concavity 55 of one pillow half 50 aligns with the interior concavity 55 of the other pillow half 50.

In an embodiment, when the pillow 10 is a queen-size pillow and each pillow half 50 is 70 cm in length and 43 cm in width, when viewing inner surface 51, each interior concavity 55 is elliptical or oval in shape with a major dimension of 30 cm along an axis aligned with the pillow length, and a minor dimension of 23 cm along an axis aligned with the pillow width. In an embodiment, when the pillow 10 is a queen-size pillow and each pillow half 50 is 6.5 cm in height, each interior concavity 55 has a maximum depth of 1 cm at a center of the interior concavity 55, and is generally arcuate in shape when viewed from the side.

In an embodiment, when the pillow 10 is a king-size pillow and each pillow half 50 is 85 cm in length and 43 cm in width, when viewing the inner surface 51, each interior concavity 55 is elliptical or oval in shape, with a major dimension of 35 cm along an axis aligned with the pillow length, and a minor dimension of 23 cm along an axis aligned with the pillow width. In an embodiment, when the pillow 10 is a king-size pillow and each pillow half 50 is 6.5 cm in height, each interior concavity 55 has a maximum depth of 1 cm at a center of the interior concavity 55, and is generally arcuate in shape when viewed from the side.

In an embodiment, one pillow half 50 of the pillow 10 has a differently sized interior concavity 55. In an embodiment, one pillow half 50 of the pillow 10 has a differently shaped interior concavity 55. In an embodiment, each pillow half 50 of the pillow 10 has a differently sized interior concavity 55. In an embodiment, each pillow half 50 of the pillow 10 has a differently shaped interior concavity 55. In an embodiment, one pillow half 50 of the pillow 10 omits the interior concavity 55. In an embodiment, each pillow half 50 of the pillow 10 omits the interior concavity 55.

In an embodiment, one or both interior concavities 55 are sized, shaped, and/or located to cradle the user's head when the user rests their head on the pillow 10. In an embodiment, one or both interior concavities 55 are sized, shaped, and/or located to reduce pressure in the sleeper's the neck area, when the user rests their neck on the pillow 10. In an embodiment, one or both interior concavities 55 are sized, shaped, and/or located to align the user's head with the user's neck.

As shown in the figures, each pillow half 50 of the pillow 10 includes surface concavities 56 formed in the outer surface 53 and extending toward an interior of the pillow half 50, such that the pillow half 50 defines the surface concavities 56. The surface concavities 56 may be in the form of depressions in the outer surface 53. The surface concavities 56 may be generally elliptical or oval in shape.

As shown in the figures, each pillow half 50 of the pillow 10 includes vents 57 formed in the outer surface 53 and extending into an interior of the pillow half 50, such that the pillow half 50 defines the vents 57. The vents 57 may be elliptical or oval in shape. The vents 57 may be formed in the surface concavities 56.

In an embodiment, when the pillow 10 is a queen-size pillow and each pillow half 50 is 70 cm in length and 43 cm in width, when viewing the outer surface 53, each vent 57 is elliptical or oval in shape with a major dimension of 3 cm along an axis aligned with the pillow length, and a minor dimension of 2 cm along an axis aligned with the pillow width. In an embodiment, when the pillow 10 is a queen-size pillow and each pillow half 50 is 70 cm in length and 43 cm in width, the pillow 10 includes thirty (30) vents 57—six (6) columns, each column including five (5) vents 57, as shown in FIG. 2. In an embodiment, when the pillow 10 is a queen-size pillow and each pillow half 50 is 70 cm in length and 43 cm in width, the vents 57 closest to the shorter edge of the pillow half 50 are spaced 11 cm from the shorter edge, and the vents 57 closest to the longer edge of the pillow half 50 are spaced 8 cm from the longer edge. In an embodiment, when the pillow 10 is a queen-size pillow and each pillow half 50 is 70 cm in length and 43 cm in width, the spacing between columns of vents 57 is 6 cm. In an embodiment, when the pillow 10 is a queen-size pillow and each pillow half 50 is 70 cm in length and 43 cm in width, the spacing between the vents 57 within each column is either 4 or 4.5 cm. In an embodiment, when the pillow 10 is a queen-size pillow and each pillow half 50 is 70 cm in length and 43 cm in width, the spacing between each vent 57 closest to the longer edges of the pillow half 50 and the next vent 57 is 4 cm, while the spacing between the other vents within each column is 4.5 cm. In an embodiment, when the pillow 10 is a queen-size pillow and each pillow half 50 is 6.5 cm in height, each vent 57 has a maximum depth of 0.5 cm. In an embodiment, when the pillow 10 is a queen-size pillow and each pillow half 50 is 6.5 cm in height, no vent 57 extends into the interior concavity 55—that is, the vents 57 are blind holes.

In an embodiment, when the pillow 10 is a king-size pillow and each pillow half 50 is 85 cm in length and 43 cm in width, when viewing the outer surface 53, each vent 57 is elliptical or oval in shape with a major dimension of 3 cm along an axis aligned with the pillow length, and a minor dimension of 2 cm along an axis aligned with the pillow width. In an embodiment, when the pillow 10 is a king-size pillow and each pillow half 50 is 85 cm in length and 43 cm in width, the pillow 10 includes thirty (30) vents 57—six (6) columns, each column including five (5) vents 57 as shown in FIG. 2. In an embodiment, when the pillow 10 is a king-size pillow and each pillow half 50 is 85 cm in length and 43 cm in width, the vents 57 closest to the shorter edge of the pillow half 50 are spaced 18.5 cm from the shorter edge, and the vents 57 closest to the longer edge of the pillow half 50 are spaced 8 cm from the longer edge. In an embodiment, when the pillow 10 is a king-size pillow and each pillow half 50 is 85 cm in length and 43 cm in width, the spacing between columns of vents 57 is 6 cm. In an embodiment, when the pillow 10 is a king-size pillow and each pillow half 50 is 85 cm in length and 43 cm in width, the spacing between the vents 57 within each column is either 4 or 4.5 cm. In an embodiment, when the pillow 10 is a king-size pillow and each pillow half 50 is 85 cm in length and 43 cm in width, the spacing between each vent 57 closest to the longer edges of the pillow half 50 and the next vent 57 is 4 cm, while the spacing between the other vents within the same column is 4.5 cm. In an embodiment, when the pillow 10 is a king-size pillow and each pillow half 50 is 6.5 cm in height, each vent 57 has a maximum depth of 0.5 cm. In an embodiment, when the pillow 10 is a king-size pillow and each pillow half 50 is 6.5 cm in height, no vent 57 extends into interior concavity 55—that is, each vent 57 is a blind hole.

In an embodiment, one or more of the vents 57 may be formed in the interior concavities 56. In an embodiment, each vent 57 may be formed in each interior concavity 56.

In an embodiment, either one pillow half 50 and/or the other pillow half 50 of the pillow 10 includes a different number of the vents 57, a different arrangement of the vents 57, different size vents 57, and/or omits the vents 57 entirely from one pillow half 50 and/or the other pillow half 50. In an embodiment, one or more vents 57 extends into the interior concavity 55.

In an embodiment, the vents 57 increase airflow through the pillow 10. In an embodiment, the vents 57 decrease thermal buildup.

In an embodiment, each pillow half 50 that forms the pillow 10 is formed by a manufacturing process of molding. In an embodiment, only one pillow half 50 is formed by molding, and the other pillow half 50 is formed by another manufacturing process. In an embodiment, neither pillow half 50 is formed by molding. In an embodiment, each pillow half 50 is formed of a polyurethane material. In an embodiment, only one pillow half 50 is formed of polyurethane, and the other pillow half 50 is formed of another material. In an embodiment, neither pillow half 50 is formed of polyurethane. In an embodiment, each pillow half 50 that forms the pillow 10 is formed by molding polyurethane. In an embodiment, only one pillow half 50 is formed by molding polyurethane. In an embodiment, neither pillow half 50 is formed by molding polyurethane.

In an embodiment, each pillow half 50 that forms the pillow 10 is formed by molding, which also forms any or all of the interior concavity 55, the surface concavities 56, and/or the vents 57. In an embodiment, the interior concavity 55 and the surface concavities 56 are formed by the molding that forms the pillow half 50, and the vents 57 are formed by a separate manufacturing process. In an embodiment, the vents 57 are formed by the molding process that forms the pillow half 50, and the interior concavity 55 and/or the surface concavities 56 in that pillow half 50 are formed by a separate manufacturing process. In an embodiment, a portion of the interior concavity 55 in one pillow half 50 is formed partially by the manufacturing process of molding which forms that pillow half 50, and one or more additional manufacturing processes complete the formation of the interior concavity 55. In an embodiment, portions of the vents 57 in one pillow half 50 are formed partially by the manufacturing process of molding which forms that pillow half 50, and one or more additional manufacturing processes complete the formation of the vents 57. In an embodiment, one pillow half 50 is adhered, bonded, glued, or otherwise connected to the other pillow half 50, thereby to form the pillow 10. In an embodiment, one pillow half 50 is connected to the other pillow half 50 before formation of the interior concavity 55. In an embodiment, one pillow half 50 is connected to the other pillow half 50 after formation of the interior concavity 55. In an embodiment, one pillow half 50 is connected to the other pillow half 50 before formation of the vents 57. In an embodiment, one pillow half 50 is connected to the other pillow half 50 after formation of the vents 57. In an embodiment, the vents 57 are formed by a press, drill, and/or other material removal process, so that the first ends of the vents 57 are on the outer surface 53 of that pillow half 50, and the second end of the vents 57 are on the inner surface 51 of that pillow half 50.

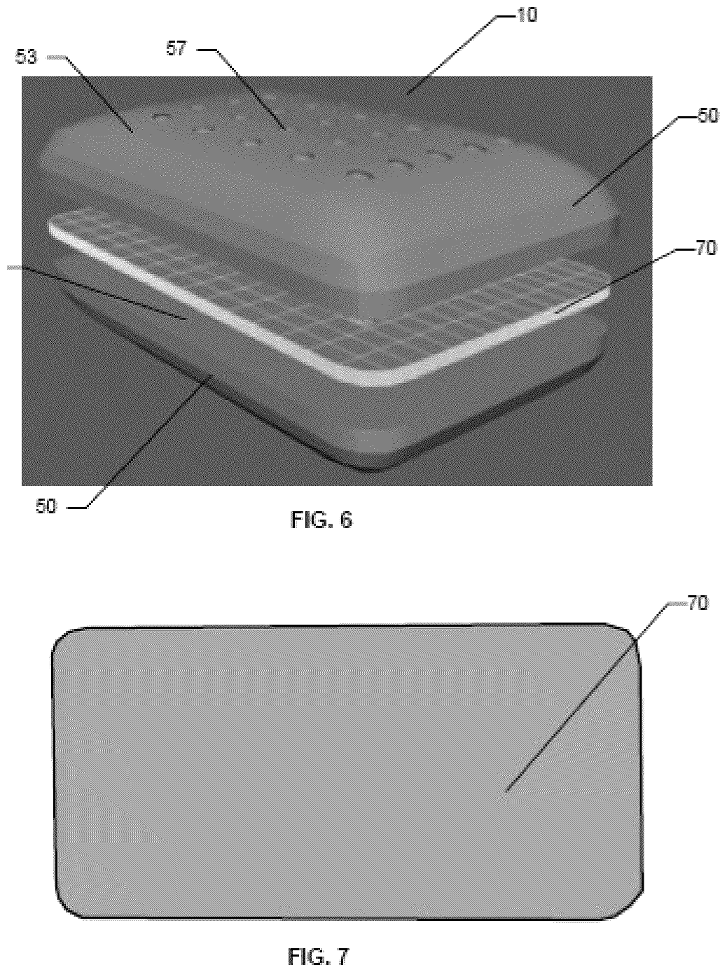

FIG. 6 is an exploded isometric view of the pillow 20 including a support layer 70. FIG. 7 is a top view of the support layer 70. As shown in the drawings, the pillow 20 includes one pillow half 50 connected to one side of the support layer 70, and another pillow half 50 connected to an opposite side of the support layer 70. In an embodiment, one pillow half 50 is adhered, bonded, glued, or otherwise connected to one side of the support layer 70, and the other pillow half 50 is adhered, bonded, glued, or otherwise connected to the other side of the support layer 70, the sides of the support layer 70 disposed opposite one another, thereby to form the pillow 20.

In an embodiment, the support layer 70 is formed by a manufacturing process of molding. In an embodiment, the support layer 70 is formed by another manufacturing process.

In an embodiment, when the pillow 20 is a queen-sized pillow, and each pillow half 50 is 70 cm in length, a corresponding side of the support layer 70 is 70 cm in length. In an embodiment, when the pillow 20 is a queen-sized pillow, and each pillow half 50 is 43 cm in width, a corresponding side of the support layer 70 is 43 cm in width. In an embodiment when the pillow 20 is a queen-sized pillow, a thickness of the support layer 70 is 0.1 cm, 0.2 cm, 0.3 cm, 0.4 cm, 0.5 cm, 0.6 cm, 0.7 cm, 0.8 cm, 0.9 cm, 1 cm, 1.5 cm, 2 cm, 2.5 cm, 3 cm, 3.5 cm, 4 cm, 4.5 cm, 5 cm, 5.5 cm, 6 cm, or 6.5 cm.

In an embodiment, when the pillow 20 is a king-sized pillow, and each pillow half 50 is 85 cm in length, a corresponding side of the support layer 70 is 85 cm in length. In an embodiment, when the pillow 20 is a king-sized pillow, and each pillow half 50 is 43 cm in width, a corresponding side of the support layer 70 is 43 cm in width. In an embodiment when the pillow 20 is a king-sized pillow, a thickness of the support layer 70 is 0.1 cm, cm, 0.3 cm, 0.4 cm, 0.5 cm, 0.6 cm, 0.7 cm, 0.8 cm, 0.9 cm, 1 cm, 1.5 cm, 2 cm, 2.5 cm, 3 cm, 3.5 cm, 4 cm, 4.5 cm, 5 cm, 5.5 cm, 6 cm, or 6.5 cm.

In an embodiment, the support layer 70 increases support of the user's head and/or neck. In an embodiment, the support layer 70 better supports the user's head and/or neck than either one and/or the other pillow half 50. In an embodiment, a material of the support layer 70 includes foam, such as polyurethane foam, latex, fibers, such as polyester fiber, feathers, gel, such as polyurethane gel, thermoplastic polyurethane (TPU), micro-innerspring system, such as a steel micro-innerspring system, and combinations thereof.

In an embodiment, one or more of the vents 57 may permit air flow from one side of the pillow 10 and/or the pillow 20, through an interior of the pillow. In an embodiment, one or more of the vents 57 may permit air flow from one side of the pillow 10 and/or the pillow 20, through both interior concavities 55. In an embodiment, one or more of the surface concavities may permit air flow over one or more surfaces of the pillow 10 and/or the pillow 20.

In some embodiments, either or both of pillow 10 and pillow 20 have the appearance of a conventional pillow.

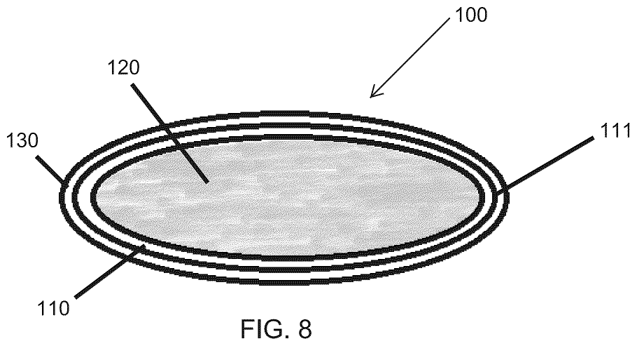

Referring to FIG. 8, in some embodiments, either or both of the pillow 10 and/or the pillow 20 is covered with a flame-retardant cover. In some embodiments, each of the pillow halves 50 form an inner core 120. In some embodiments, either or both of the pillows 10, 20 includes an inner cover 110 formed of a flame-retardant, thermally-insulating fabric 111. In an embodiment, the fabric minimizes or excludes fiberglass or other components that fragment to form irritating or toxic particles.

In an embodiment, the flame-retardant, thermally-insulating fabric 111 is a woven fabric. In an embodiment, the flame-retardant, thermally-insulating fabric 111 is a non-woven fabric. In an embodiment, the flame-retardant, thermally-insulating fabric 111 is a knit fabric.

In an embodiment, the flame-retardant, thermally-insulating fabric 111 includes a batt which contains flame-retardant fibers. Examples of suitable flame-retardant fibers include, without limitation, flame-retardant rayon, polyaramids (e.g., NOMEX® or KEVLAR®), elastanes (e.g., polyurethane, SPANDEX®, LYCRA®), flame-retardant polyesters, and combinations thereof. As used herein, “flame-retardant rayon” includes inherently flame-retardant cellulosic fibers such as, without limitation, rayon with incorporated silica, and cellulosic fibers with incorporated flame thermally-retardant chemicals (e.g., phosphorous compounds). In some embodiments, the batt consists of flame-retardant rayon fibers. In some embodiments, the batt comprises a combination of flame-retardant rayon fibers and fibers made of one or more of polyaramids (e.g., NOMEX® or KEVLAR®), elastanes (e.g., polyurethane, SPANDEX®, LYCRA®), and flame-retardant polyesters.

In an embodiment of the flame-retardant, thermally-insulating fabric 111, 100% by weight of the fibers in the batt are inherently flame-retardant cellulosic fibers. In an embodiment, at least 40% by weight of the fibers in the batt are flame-retardant rayon fibers, based on the total weight of the batt, with the remainder being other flame-retardant fibers and/or non-flame-retardant fibers. In an embodiment, the batt is a blend of inherently flame-retardant cellulosic fibers with other flame-retardant and/or non-flame-retardant fibers. Exemplary blends include, without limitation, inherently flame-retardant cellulosic fibers with one or more of the following fiber types: polyaramids, polyesters, polyurethanes, or other elastanes, acrylics, modacrylics, non-flame-retardant cellulosic fibers (e.g., cotton or bamboo), wool, cashmere, or silk.

Further exemplary blends include inherently flame retardant cellulosic fibers and one or more of polyaramid fibers in the range of 0% to 30% of the total weight of the fibers, polyester fibers in the range of 0% to 20% of the total weight of the fibers, and modacrylic fibers in the range of 0% to 50% of the total weight of the fibers. In an embodiment, the blend of flame-retardant cellulosic fibers and one or more of polyaramid fibers are in the range of 5% to 30% of the total weight of the fibers. In an embodiment, the blend of flame-retardant cellulosic fibers and one or more of polyaramid fibers are in the range of 5% to 25% of the total weight of the fibers. In an embodiment, the blend of flame-retardant cellulosic fibers and one or more of polyaramid fibers are in the range of 5% to 20% of the total weight of the fibers. In an embodiment, the blend of flame-retardant cellulosic fibers and one or more of polyaramid fibers are in the range of 5% to 15% of the total weight of the fibers. In an embodiment, the blend of flame-retardant cellulosic fibers and one or more of polyaramid fibers are in the range of 5% to 10% of the total weight of the fibers. In an embodiment, the blend of flame-retardant cellulosic fibers and one or more of polyaramid fibers is 5% of the total weight of the fibers. In an embodiment, the blend of flame-retardant cellulosic fibers and one or more of polyaramid fibers is 10% of the total weight of the fibers. In an embodiment, the blend of flame-retardant cellulosic fibers and one or more of polyaramid fibers is 15% of the total weight of the fibers. In an embodiment, the blend of flame-retardant cellulosic fibers and one or more of polyaramid fibers is 20% of the total weight of the fibers. In an embodiment, the blend of flame-retardant cellulosic fibers and one or more of polyaramid fibers is 25% of the total weight of the fibers. In an embodiment, the blend of flame-retardant cellulosic fibers and one or more of polyaramid fibers is 30% of the total weight of the fibers. In an embodiment, the polyester fibers in the range of 0% to 20% of the total weight of the fibers. In an embodiment, the polyester fibers in the range of 5% to 20% of the total weight of the fibers. In an embodiment, the polyester fibers in the range of 10% to 20% of the total weight of the fibers. In an embodiment, the polyester fibers in the range of 15% to 20% of the total weight of the fibers. In an embodiment, the polyester fibers in the range of 5% to 15% of the total weight of the fibers. In an embodiment, the polyester fibers in the range of 5% to 10% of the total weight of the fibers. In an embodiment, the polyester fibers in the range of 10% to 15% of the total weight of the fibers. In an embodiment, the modacrylic fibers in the range of 0% to 50% of the total weight of the fibers. In an embodiment, the modacrylic fibers in the range of 5% to 50% of the total weight of the fibers. In an embodiment, the modacrylic fibers in the range of 10% to 50% of the total weight of the fibers. In an embodiment, the modacrylic fibers in the range of 15% to 50% of the total weight of the fibers. In an embodiment, the modacrylic fibers in the range of 20% to 50% of the total weight of the fibers. In an embodiment, the modacrylic fibers in the range of 25% to 50% of the total weight of the fibers. In an embodiment, the modacrylic fibers in the range of 30% to 50% of the total weight of the fibers. In an embodiment, the modacrylic fibers in the range of 35% to 50% of the total weight of the fibers. In an embodiment, the modacrylic fibers in the range of 40% to 50% of the total weight of the fibers. In an embodiment, the modacrylic fibers in the range of 45% to 50% of the total weight of the fibers. In an embodiment, the modacrylic fibers in the range of 10% to 40% of the total weight of the fibers. In an embodiment, the modacrylic fibers in the range of 20% to 40% of the total weight of the fibers. In an embodiment, the modacrylic fibers in the range of 30% to 40% of the total weight of the fibers. In an embodiment, the modacrylic fibers in the range of 10% to 30% of the total weight of the fibers. In an embodiment, the modacrylic fibers in the range of 20% to 30% of the total weight of the fibers.

In an embodiment of the flame-retardant, thermally-insulating fabric 111, the density of the fibers of the batt is in the range of from 1.5 denier to 7 denier. In an embodiment, the density of the fibers of the batt is in the range of from 1.5 denier to 6 denier. In an embodiment, the density of the fibers of the batt is in the range of from 1.5 denier to 5 denier. In an embodiment, the density of the fibers of the batt is in the range of from 1.5 denier to 4 denier. In an embodiment, the density of the fibers of the batt is in the range of from 1.5 denier to 3 denier. In an embodiment, the density of the fibers of the batt is in the range of from 3.5 to 5.5 denier. In an embodiment, the density of the fibers of the batt is in the range of from 4 to 5 denier.

In an embodiment, the batt is from 60% to 90% by weight of the total weight of the fabric. In an embodiment, the batt is from 70% to 90% by weight of the total weight of the fabric. In an embodiment, the batt is from 80% to 90% by weight of the total weight of the fabric. In an embodiment, the batt is from 60% to 80% by weight of the total weight of the fabric. In an embodiment, the batt is from 60% to 70% by weight of the total weight of the fabric. In an embodiment, the batt is from 75% to 85% by weight of the total weight of the fabric. In an embodiment, the batt is 80% by weight of the total weight of the fabric. In an embodiment, the batt is 70% by weight of the total weight of the fabric. In an embodiment, the batt is 60% by weight of the total weight of the fabric. In an embodiment, the batt is 90% by weight of the total weight of the fabric. In an embodiment, the batt is 95% by weight of the total weight of the fabric. In an embodiment, the batt is 99% by weight of the total weight of the fabric. In an embodiment, the batt is 100% by weight of the total weight of the fabric.

In an embodiment, the flame-retardant, thermally-insulating fabric 111 does not include any binders or binding materials, such as thermoplastics or latexes.

In an embodiment, the weight of the flame-retardant, thermally-insulating fabric 111 is in the range of 175 gsm to 500 grams per square meter (gsm). In an embodiment, the weight of the fabric is in the range of 200 gsm to 500 grams per square meter (gsm). In an embodiment, the weight of the fabric is in the range of 225 grams per square meter (gsm) to 500 grams per square meter (gsm). In an embodiment, the weight of the fabric is in the range of 300 grams per square meter (gsm) to 500 grams per square meter (gsm). In an embodiment, the weight of the fabric is in the range of 400 grams per square meter (gsm) to 500 grams per square meter (gsm). In an embodiment, the weight of the fabric is in the range of 175 grams per square meter (gsm) to 225 grams per square meter (gsm). In an embodiment, the weight of the fabric is in the range of 200 grams per square meter (gsm) to 225 grams per square meter (gsm). In an embodiment, the weight of the fabric is in the range of 225 grams per square meter (gsm) to 300 grams per square meter (gsm). In an embodiment, the weight of the fabric is in the range of 225 grams per square meter (gsm) to 400 grams per square meter (gsm). In an embodiment, the weight of the fabric is in the range of 225 grams per square meter (gsm) to 500 grams per square meter (gsm). In an embodiment, the weight of the fabric is 175 grams per square meter (gsm). In an embodiment, the weight of the fabric is 200 grams per square meter (gsm). In an embodiment, the weight of the fabric is 225 grams per square meter (gsm). In an embodiment, the weight of the fabric is 300 grams per square meter (gsm). In an embodiment, the weight of the fabric is 400 grams per square meter (gsm). In an embodiment, the weight of the fabric is 500 grams per square meter (gsm). In an embodiment, the weight of the fabric is greater than 225 grams per square meter (gsm). In an embodiment, the weight of the fabric is less than 225 grams per square meter (gsm). In an embodiment, the weight of the fabric is greater than 300 grams per square meter (gsm). In an embodiment, the weight of the fabric is less than 300 grams per square meter (gsm). In an embodiment, the weight of the fabric is greater than 400 grams per square meter (gsm). In an embodiment, the weight of the fabric is less than 400 grams per square meter (gsm). In an embodiment, the weight of the fabric is less than 500 grams per square meter (gsm).

In an embodiment of the thermally-insulating fabric 111, the fabric is a coated fabric, wherein the coating is applied to the fabric. In an embodiment of the coated fabric, the coating includes one or more flame-retardant chemicals. In an embodiment of the coated fabric, the coating includes a nanoclay. In an embodiment of the coated fabric, the coating includes graphite. In an embodiment, the fabric does not have a coating.

In an embodiment, the batt includes inherently flame-retardant viscose fibers. In an embodiment, all of the fibers in the batt are flame retardant viscose fibers. In an embodiment, the batt includes a blend of fibers made from different materials. In an embodiment, the fibers of the batt include fibers that shrink when heated to a critical temperature specific to the material of the fiber. In an embodiment, the fibers of the batt consist of fibers that shrink when heated to a critical temperature specific to the material of the fiber.

In an embodiment, the fibers in the batt include fibers of different denier. In an embodiment, the fibers in the batt consist of fibers of approximately the same denier.

In an embodiment, the inner cover 110 is sewn closed on all sides, to prevent removal of the inner core 120 of the pillows 10, 20 from within the inner cover 110 without removing one or more sections of seam from the inner cover 110. In an embodiment, one or more of the seams is thread formed of flame-retardant fibers. Examples of suitable flame-retardant fibers include, without limitation, flame-retardant rayon, polyaramids (e.g., NOMEX® or KEVLAR®), elastanes (e.g., polyurethane, SPANDEX®, LYCRA®), flame-retardant polyesters, and combinations thereof. In an embodiment, all of the seams are thread formed of flame-retardant fibers. In an embodiment, one or more of the seams are thread formed of non-flame-retardant fibers. In an embodiment, one or more of the seams are thread formed of non-flame-retardant fibers. In an embodiment, all of the seams are thread formed of non-flame-retardant fibers. In an embodiment, the inner cover 110 includes at least one open end with a flap, such that after placing the inner core 120 within the inner cover 110, folding over the flap results in the inner cover 110 covering the entire inner core 120. In an embodiment, the inner cover 110 has a J-shaped flap. In an embodiment, the flap is sewn closed with flame-retardant or non-flame retardant thread. In an embodiment, the flap is not sewn closed.

In an embodiment, the inner cover 110 causes the inner core 120 of the pillows 10, 20 to conform to a flame-retardancy standard that does not exceed a maximum heat release rate of 200 kW with a total heat release of 15 Mj (megajoules), similar to the requirements of CPSC 16 CFR 1633 testing methodology that is applied to mattresses. In an embodiment, the inner cover 110 prevents ignition of the inner core 120 when the pillows 10, 20 are exposed to an open flame for one minute or less.

In some embodiments, either or both of the pillows 10, 20 includes an outer cover 130 that covers the inner cover 110. Examples of suitable materials for the outer cover 130 includes, without limitation, woven fabrics, non-woven fabrics, knit fabrics, and combinations thereof. In an embodiment, the outer cover 130 is made from a flame-retardant, thermally-insulating fabric 111 described above. In an embodiment, the outer cover 130 is made from the same flame-retardant, thermally-insulating fabric 111 as the inner cover 110. In an embodiment, the outer cover 130 is made from a different flame-retardant, thermally-insulating fabric 111 than the inner cover 110. In an embodiment, the outer cover 130 is not made from a flame-retardant, thermally-insulating fabric 111. In an embodiment, the outer cover 130 comprises a same non-flame-retardant material as the inner cover 110. In an embodiment, the outer cover 130 comprises a different non-flame-retardant material than the inner cover 110. In an embodiment, both the outer cover 130 and the inner cover 110 comprise flame-retardant materials. In an embodiment, both the outer cover 130 and the inner cover 110 comprise non-flame-retardant materials.

In an embodiment, the flame-retardant characteristics of the pillows 10, 20 do not negatively impact any or all of the feel, performance, aesthetics, and durability of any or all of the pillows 10, 20 itself, the inner core 120, the inner cover 110, and the outer cover 130.

With continued reference to FIG. 8, the pillow 100 includes the inner core 120 covered by the inner cover 110. In an embodiment, the inner cover 110 covers the inner core 120 directly—that is, without any additional layer disposed between the inner cover 110 and the inner core 120. In an embodiment, there are one or more additional layers (not shown) between the inner cover 110 and the inner core 120. In an embodiment, the inner core 120 includes an inner-core material such as one or more of those discussed above.

In some embodiments, the pillow 100 includes the outer cover 130 covering the inner cover 110. In an embodiment, the outer cover 130 covers the inner cover 110 directly—that is, without any additional layer disposed between the outer cover 130 and the inner cover 110. In an embodiment, there are one or more additional layers (not shown) between the outer cover 130 and the inner cover 110. In an embodiment, the outer cover 130 includes an outer-core material such as one or more of those discussed above. In an embodiment, the outer cover 130 may be covered by another layer. In an embodiment, the outer cover 130 is covered by a sham. In an embodiment, the outer cover 130 is covered by a pillowcase.

It should be understood that the embodiments described herein are merely exemplary in nature and that a person skilled in the art may make many variations and modifications thereto without departing from the scope of the present invention. All such variations and modifications, including those discussed above, are intended to be included within the scope of the embodiments.

What is claimed is:

1. A pillow, comprising:
a first pillow half including an outer surface and an inner surface opposite the outer surface; and
a second pillow half including an outer surface and an inner surface opposite the outer surface,
wherein the inner surface of the first pillow half contacts the inner surface of the second pillow half,
wherein the first pillow half defines a first interior concavity in the inner surface of the first pillow half, and
wherein the first interior concavity extends into an interior of the first pillow half.

2. The pillow of claim 1, wherein the second pillow half defines a second interior concavity in the inner surface of the second pillow half, the second interior concavity extending into an interior of the second pillow half, the second interior concavity aligned with the first interior concavity.

3. The pillow of claim 2, wherein the first pillow half defines a first vent in the outer surface of the first pillow half, the first vent extending into the interior of the first pillow half.

4. The pillow of claim 3, wherein the second pillow half defines a second vent in the outer surface of the second pillow half, the second vent extending into the interior of the second pillow half.

5. The pillow of claim 4, wherein the first pillow half defines a plurality of first vents in the outer surface of the first pillow half, the plurality of first vents extending into the interior of the first pillow half, and wherein the second pillow half defines a plurality of second vents in the outer surface of the second pillow half, the plurality of second vents extending into the interior of the second pillow half.

6. The pillow of claim 5, wherein the plurality of first vents and the plurality of second vents extend into the first and second interior concavities.

7. The pillow of claim 6, wherein the first pillow half comprises a molded polyurethane.

8. A pillow comprising:
a first pillow half including an outer surface and an inner surface opposite the outer surface;
a second pillow half including an outer surface and an inner surface opposite the outer surface; and
a support layer having a first surface and a second surface opposite the first surface,
wherein the inner surface of the first pillow half contacts the first surface of the support layer,
wherein the inner surface of the second pillow half contacts the second surface of the support layer, and
wherein the first pillow half defines a first interior concavity in the inner surface of the first pillow half, the first interior concavity extending into an interior of the first pillow half.

9. The pillow of claim 8, wherein the second pillow half defines a second interior concavity in the inner surface of the second pillow half, the second interior concavity extending into an interior of the second pillow half.

10. The pillow of claim 9, wherein the first pillow half defines a first vent in the outer surface of the first pillow half, the first vent extending into the interior of the first pillow half.

11. The pillow of claim 10, wherein the second pillow half defines a second vent in the outer surface of the second pillow half, the second vent extending into the interior of the second pillow half.

12. The pillow of claim 11, wherein the first pillow half defines a plurality of first vents in the outer surface of the first pillow half, the plurality of first vents extending into an interior of the first pillow half, and wherein the second pillow half defines a plurality of second vents in the outer surface of the second pillow half, the plurality of second vents extending into an interior of the second pillow half.

13. The pillow of claim 12, wherein the plurality of first vents and the plurality of second vents extend into the first and second interior concavities.

14. The pillow of claim 13, wherein the first pillow half comprises a molded polyurethane.

15. A method, comprising:
molding a first pillow half, wherein the first pillow half includes an outer surface, an inner surface opposite the outer surface, and a first interior concavity in the inner surface, wherein the first inner concavity extends into an interior of the first pillow half;
molding a second pillow half, wherein the second pillow half includes an outer surface and an inner surface opposite the outer surface of the second pillow half; and
connecting the inner surface of the first pillow half and the inner surface of the second pillow half, thereby to form a pillow.

16. The method of claim 15, wherein molding the second pillow half comprises molding a second interior concavity in the inner surface of the second pillow half, wherein the second interior concavity extends into an interior of the second pillow half, and wherein the second interior concavity is aligned with the first interior concavity.

17. The method of claim 16, wherein molding the first pillow half comprises molding a first vent in the outer surface of the first pillow half, and wherein the first vent extends into the interior of the first pillow half.

18. The method of claim 17, wherein molding the second pillow half comprises molding a second vent in the outer surface of the second pillow half, and wherein the second vent extends into the interior of the second pillow half.

19. A method, comprising:
molding a first pillow half including an outer surface, an inner surface opposite the outer surface, and an interior concavity in the inner surface, the inner concavity extending into an interior of the first pillow half;
molding a second pillow half including an outer surface and an inner surface opposite the outer surface of the second pillow half;
obtaining a support layer including a first surface and a second surface opposite the first surface;
connecting the inner surface of the first pillow half to the first surface of the support layer; and
connecting the inner surface of the second pillow half to the second surface of the support layer, thereby to form a pillow.

20. The method of claim 19, wherein molding the first pillow half comprises molding a first vent in the outer surface of the first pillow half, and wherein the first vent extends into the interior of the first pillow half.
